(19) United States
(12) Patent Application Publication
(10) Pub. No.: US 2002/0138365 A1
(43) Pub. Date: Sep. 26, 2002

(54) Information processing for offering price for disused appliance for recycling

(75) Inventor: Junichi Matsubara, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,856

(22) Filed: Mar. 21, 2002

(30) Foreign Application Priority Data
Mar. 23, 2001 (JP) 2001-84917

(51) Int. Cl. G06F 17/60

(52) U.S. Cl. 705/26

(57) ABSTRACT

A program for use with an information processing apparatus offers a price of an appliance to be disposed of is. The program is operable to effect the step of providing an accepting price at which the appliance is to be accepted for disposal. The accepting price is determined in accordance with appliance data of the appliance and disposal way data representing a way of disposing of the appliance. The program is operable to further effect the step of sending a message of a request for accepting and taking away from the consumer the appliance for disposal to an information processing apparatus of a business concern related in the disposal way, which is determined based on the data of the designated disposal way.

This invention relates to determining a way of disposing of disused or unnecessary articles, through a network, such as the Internet, and, more particularly, to allowing consumers to select the most advantageous way of disposing of their disused or unnecessary household appliances.

### BACKGROUND OF THE INVENTION

In Japan, disused or unnecessary household appliances are usually taken by local governments or retail shops free of charge or at consumers' costs. If the appliances are reusable, the consumers can sell them to secondhand shops. In the past, if the appliances were no longer useable, they were generally destined to be discarded. The recent law that came into force on Apr. 1, 2001 in Japan, generally called the “Household Appliance Recycling Law” (hereinafter referred to as “the Law”), provides the duties to be done by household appliance manufacturers and importers, shops, and consumers or the like who wish to dispose of household appliances specified by the law, i.e. air conditioners, CRT-type television sets, refrigerators and washing machines. According to the Law, the manufacturers and importers must recycle the specified household appliances or their parts or materials, the retail shops must collect and transport such appliances, and the consumers bear the expenses for the recycling.

As long as the consumers dispose of the specified household appliances in accordance with the Law, they have to pay the fees as provided by the Law for the appliances indiscriminately whether they are no longer reusable or reusable by some means, i.e., even when the appliances are still under guarantee, when guarantee terms of the appliances have expired but they are still useable, and when they include valuable, recyclable parts or materials. Since such a burden of payment on the consumers is relatively large, and the legal procedure to be followed is relatively complicated, the consumers may be discouraged to recycle the disused appliances, and it is anticipated that illegal disposal of such appliances occurs more frequently.

The inventor has recognized that, if disused appliances for disposal are evaluated positively as recyclable resources so that the consumers can receive some payback or can pay the disposal fee reduced by some amount, the consumers will be more encouraged to apply their disused appliances to recycling. The inventor has also recognized that, if the consumers can know and select advantageous ways of disposing of their disused appliances for recycling or reuse, taking parts and materials of such appliances into account, then they will recognize their disused appliances as valuable resources, their potentially recyclable disused appliances will be recycled more efficiently, and illegal disposal of appliances which may destroy the environment will be more effectively prevented.

Accordingly, an object of the present invention is to provide a system that allows consumers to determine how to dispose advantageously of disused articles.

### SUMMARY OF THE INVENTION

According to an aspect of the present invention, an information processing apparatus offers a price of an appliance to be disposed of. A processor of the information processing apparatus provides a price for accepting the appliance for disposal. The accepting price is determined in accordance with appliance data of the appliance and disposal way data representing a way of disposing of the appliance.

According to another aspect of the invention, a program for use with an information processing apparatus offers a price of an appliance to be disposed of. The program is operable to effect the step of providing a price for accepting the appliance for disposal. The accepting price is determined in accordance with appliance data of the appliance and disposal way data representing a way of disposing of the appliance.

The program is operable to further effect the step of sending, in accordance with the disposal way data entered by a consumer, a message to an information processing apparatus of a business concern related to the disposal way, to request the business concern to accept and take away the appliance from the consumer.

The program is operable to further effect the step of sending, in accordance with said disposal way data entered by a consumer, the appliance data to an information processing apparatus of a business concern related to the disposal way.

According to a further aspect of the invention, a method offers a price of an appliance to be disposed of, in an appliance accepting price offering system. The method includes the step of providing a price for accepting the appliance for disposal. The accepting price is determined in accordance with appliance data of the appliance and disposal way data representing a way of disposing of the appliance.

According to a still further aspect of the invention, a system promotes recycling of appliances. The system receives information related to an appliance sought to be accepted for disposal from one of a plurality of terminals over a network. In response to the received information, the system sends, to the terminal, a price for accepting the appliance that is determined in accordance with an evaluated price of the appliance for recycling and with a predetermined cost for receiving and taking away of the appliance. The evaluated price for recycling is predetermined by each of business concerns including a manufacturer. The system receives, from the terminal, a request for accepting the appliance at the accepting price. In response to the received request, the system sends, to one of the business concerns, another request for accepting and taking away the appliance for disposal.

In this manner, according to the present invention, a system allowing determination of an advantageous way of disposing of disused articles is provided.

### BRIEF DESCRIPTION OF THE DRAWINGS

FIG. 1 shows a system for intermediating, over a network, between consumers and business concerns for accepting disused appliances, according to an embodiment of the present invention;

FIG. 2 shows a flow diagram of the intermediating process performed by an intermediating server in accordance with operations and/or selections performed by a consumer which are received by the server from a consumer client; and

FIG. 3 shows an example of a display screen of a list including information about a prospective household appliance to be disposed of as entered by a consumer, and appliance accepting prices for the appliance calculated for respective ones of business concerns who are to accept and dispose of the appliance.

### DETAILED DESCRIPTION OF PREFERRED EMBODIMENT

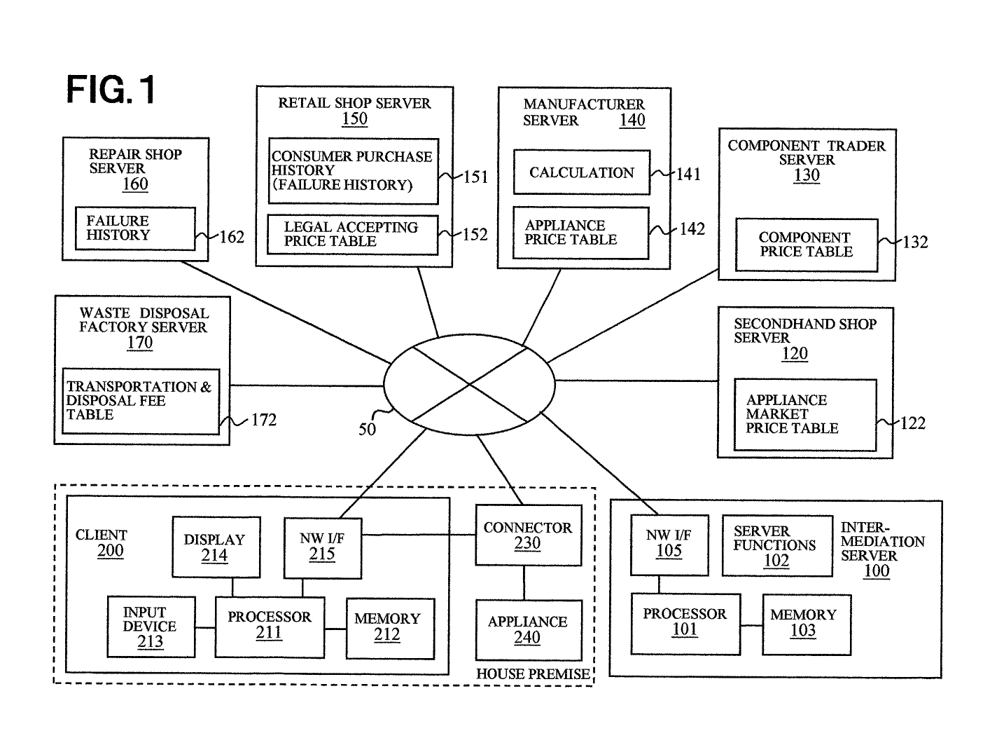

FIG. 1 shows a system for intermediating, over a network, between consumers or users and one or more of secondhand shops, component traders, manufacturers, retail shops, repair shops, waste disposal factories, and the like (hereinafter referred collectively to as business concerns) that run business related to disposal and recycling or reuse of disused appliances. The system exemplified in FIG. 1 is formed of a recycling intermediation server machine (hereinafter sometimes referred to “server”) 100 controlled and managed by a recycling intermediator, a secondhand shop server machine 120 managed and controlled by a secondhand shop, and a component trader server machine 130 managed and controlled by a component trader. The system also includes a manufacturer server machine 140 managed and controlled by an appliance manufacturer, a retail shop server machine 150 managed and controlled by an appliance shop, a repair shop server machine 160 managed and controlled by an appliance repair shop, a waste disposal factory server machine 170 managed and controlled by a waste treatment factory, and a consumer client machine 200 of a consumer who has a household appliance. These machines are connected to the intermediation server 100 and or to each other via a network 50. A plurality of such machines 120-170 and a plurality of clients similar to the client 200 may be connected to the server 100 and/or to each other over the network 50.

The network 50 typically includes the Internet, a telephone network and/or a cable television network.

The consumer's client machine (hereinafter sometimes referred to as “client”) 200 may be an ordinary personal computer (PC) which has a processor 211, a memory 212, an input device 213, e.g. a keyboard and/or a mouse, a display 214 and a network interface 215. Alternatively, a dedicated information processing apparatus of similar arrangement may be used. The client machine 200 may be connected either directly or through a connector 230 to the network 50.

A household appliance 240 installed in the consumer's house may be of an ordinary stand-alone type, or a so-called “Internet-connected appliance” connected to the network 50. In FIG. 1, it is assumed that the client 200, the connector 230 and the household appliance 240 are disposed in the same house. If the appliance 240 is an Internet-connected appliance, it may be connected through a network interface (not shown) provided for it and possibly through the connector 230 to the network 50, so that it can send and receive data to and from other information processing apparatuses connected to the network 50.

Alternatively, the household appliance 240 may be arranged similarly to the client 200 and, may include components similar to the processor 211, the memory 212, the input device 213, the display 214 and the network interface 215 so that it can also function as the client 200.

The recycling intermediation server machine 100 typically has a processor 101, a memory 103, e.g. a magnetic disc, a network interface 105 connected to the network 50, a display (not shown), and keyboard (not shown). The server machine 100 also has a recycling intermediation server function 102 implemented in the form of an application program stored in a memory. Alternatively, the server function 102 may be implemented as a dedicated processor in the form of hardware, e.g. an integrated circuit.

Each of the server machines 120, 130, 140, 150, 160 and 170 also has an arrangement similar to the server 100 and typically includes a processor, a memory, e.g. a magnetic disc, a network interface connected to the network 50, a display, and a keyboard. Each of the server machines 120, 130, 140, 150, 160 and 170 has also a corresponding server function implemented in the form of an application program stored in the memory. The server function may alternatively be implemented as a dedicated processor in the form of hardware, e.g. an integrated circuit.

The secondhand shop server 120 includes also a market appliance accepting price table 122 stored in a region in the memory thereof. The table 122 contains market appliance accepting prices for accepting appliances sorted by kind or class at which the secondhand shop will accept or buy them, and is managed and renewed by an operator of the secondhand shop.

The component trader server machine 130 includes also an appliance and component market price table 132 in a region in the memory thereof. The price table 132 contains kinds, names or identifications of reusable components contained in appliances sorted by appliance kind and manufacturer. The table 132 includes also prices at which the component trader will buy respective components. The table 132 is managed and renewed by an operator of the component trader.

The manufacturer server machine 140 includes also, as part of its server function, an appliance accepting price calculating function 141 for calculating appliance accepting prices for appliances sorted by kind and model. The server machine 140 includes also an appliance accepting price table 142 in a region in the memory thereof. The price table 142 contains appliance accepting prices for appliances sorted by kind and model at which the manufacturer will accept them for disposal. The table 142 contains also data of current and future accepting prices of respective kinds of appliances shown by month. In general, the future accepting or buying prices decrease month by month toward zero or, sometimes, become negative.

The retail shop server machine 150 includes also a consumer purchase history database 151 for each consumer, and a table 152 of legal appliance accepting prices and collection and transportation costs for appliances of respective kinds. The database 151 and the table 152 are stored in respective regions in the memory of the server 150. The consumer purchase history database 151 has a record of each of appliances each consumer bought containing its appliance name or class, name of the manufacturer, model identification, product number and date of manufacture, the date of sale (i.e. the date on which that consumer bought it), the guarantee number and the term of guarantee for it, a failure and repair history (i.e., how it failed, how it was repaired, what component was repaired or replaced, the date on which the repair was done, the guarantee terms of replaced components), and the like. The database 151 and the table 152 are managed and renewed by an operator of the retail shop.

The repair shop server machine 160 includes further a failure and repair history database 162 stored in a region in the memory thereof. The database 162 contains a record of an appliance which a consumer, a retail shop or the like has ordered to repair, including the appliance class or name, the name of the manufacturer, the model identification, the product number, the date of manufacture, how it failed, what and how it was repaired, the date on which it was repaired, and the guarantee term of components replaced. The database 162 is managed and renewed by an operator of the repair shop.

The waste disposal factory server machine 170 includes further a transportation and disposal fee table 172 in a region in the memory thereof. The table 172 stores current transportation and disposal fees for household appliances of each kind, and is managed and renewed by an operator of the waste disposal factory.

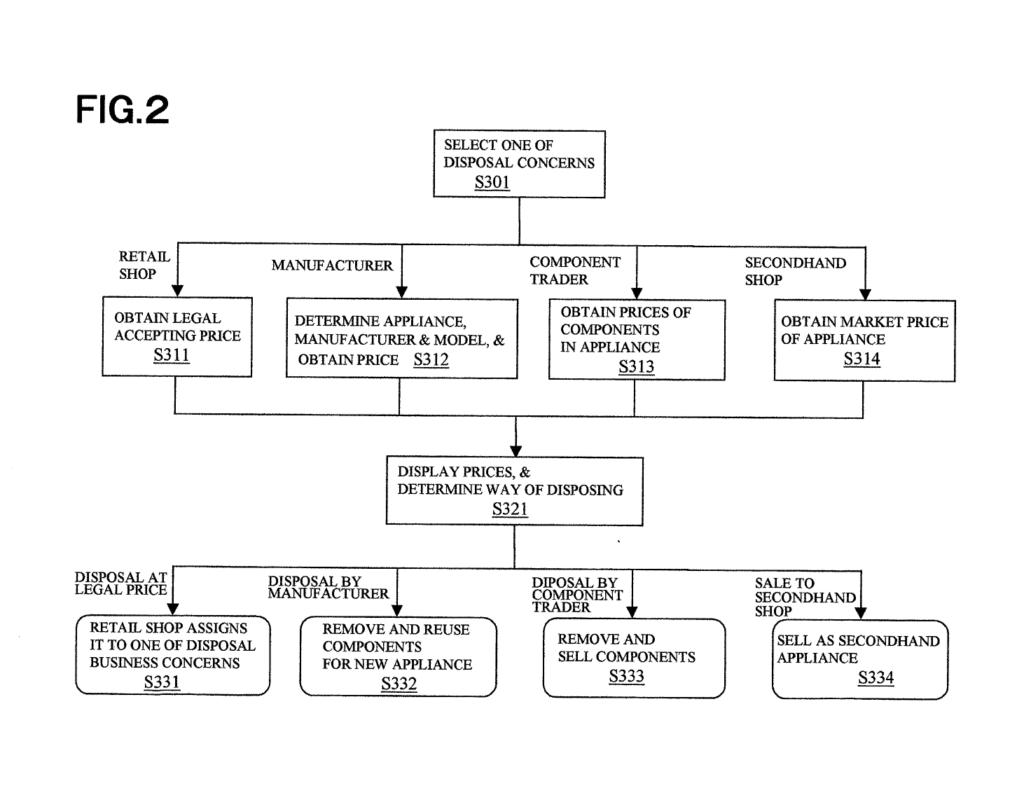

Now, operation of each of the client 200 and the servers 100, 120, 130, 140, 150, 160 and 170 shown in FIG. 1 is described with reference to FIG. 2. FIG. 2 shows a flow diagram of the intermediating process performed by the intermediation server 100 in accordance with the operations and/or selections by the consumer sent from the client 200.

First, the consumer, seeing the screen of the display 214 of the client 200, enters his or her user ID, a password assigned to him or her, and the like to log in over the network 50 to the recycling intermediation server function 102 of the intermediation server 100.

At Step 301 in FIG. 2, the intermediation server function 102 sends back to the client 200, data of a screen or picture to be displayed on the display 214 through which the consumer can select an appliance disposal business concern or a way or manner of disposing of the appliance. It is assumed that once the disposal business concern is determined, the way of disposal is automatically determined correspondingly, and vice versa. The disposal business concerns from which the consumer can select may include, for example, a retail shop, a manufacturer, a component trader, and a secondhand shop, which are all displayed on the display 214. The consumer selects one of the disposal business concerns, seeing the screen of the display 214, and enters appliance data of the household appliance 240 which is or will be no longer used, for transmission to the intermediation server 100. Upon receipt of the selection of the business concern and the appliance data entered by the consumer, the server 100 connects itself to one of the servers 120, 130, 140 and 150 that corresponds to the selected appliance disposal business concern. Then, the server 100 causes the accepting price or prices of the household appliance 240 to be displayed on the screen of the display 214 of the client 200 in the manner described below.

It is assumed that, at Step 301 in FIG. 2, the consumer, using the input device 213 of the client 200, selects “Retail Shop” on the screen of the disposal business concern selection on the display 214, and enters appliance data including the kind or class of the household appliance 240, e.g. “refrigerator”, which the consumer no longer uses or will be disused, the name of the appliance, the model identification, the manufacturer, the retail shop at which the consumer bought the appliance, and the date on which the appliance was bought, and sent the appliance data to the intermediation server 100. Then, the procedure advances to Step 311, where the server 100, in response the received selection and appliance data, connects itself over the network 50 to the retail shop server 150 of the retail shop in the appliance data or of a retail shop with which the intermediator ties up. The server 100 obtains the legal accepting price and the collection and transportation fee for the entered appliance and manufacturer contained in the legal accepting price and collection and transportation fee table 152 in the server 150. Then, the server 100 causes the display 214 to display the legal accepting price (L) for the appliance in interest, the collection and transportation fee (C), and the sum (L+C) of the legal accepting price (L) and the collection and transportation fee (C), which is the total accepting price the consumer is required to pay the shop.

At Step 301, the consumer may select “Manufacturer” on the screen of the display 214 and enter appliance data and the desired acceptance date on which the consumer wants the appliance to be taken away, for transmission to the intermediation server 100. The appliance data includes the kind of the household appliance 240, e.g. “refrigerator”, which the consumer no longer uses or will be disused, the name of the appliance, the name of the manufacturer, the model identification, the product number, the retail shop at which the consumer bought the appliance.

If the household appliance 240 is an Internet-connected electric appliance, which is connected to the network 50, the consumer may operate on the appliance 240 to cause the appliance data stored in its memory to be sent via the client 200 or directly to the server 100. The memory of the Internet-connected appliance 240 stores therein the appliance data of the appliance 240 including the name of the appliance, the name of the manufacturer, the model identification, the date of manufacture, the product number, and the failure and repair information.

The intermediation server 100, upon receipt of the selection of “Manufacturer” as the disposal business concern, and the entered appliance data, from the client 200, connects itself via the network 50 to the appropriate manufacturer server 140 at Step 312. The server 100, then, looks up the appliance accepting price table 142 which contains the accepting price of the entered consumer's appliance 240 as the component resource, and displays the accepting price of the appliance 240 on the display 214 of the client 200. The accepting price is the price expected to be on the desired acceptance date the consumer wants the appliance 240 to be taken away. In this case, if the date on which the consumer wants the appliance to be taken away is a day one ore more months later, the intermediation server 100 may present, in addition to the expected accepting price for the desired acceptance day, the accepting prices in the present month and the subsequent months before the acceptance day. The accepting price is the sum of the prices of the reusable components the appliance 240 has, minus the accepting and disposal costs including the collection and transportation fee, the cost for removing the components from the appliance and the cost for disposing of the remainder components and material. Thus, the accepting price can be zero, a negative value or a positive value.

The accepting price is calculated by the appliance accepting price calculating function 141 of the manufacturer server 140. If the calculated amount is a positive value, the consumer can receive that amount. On the other hand, if the calculated amount is a negative value, the consumer must pay the amount. The accepting price can be expressed as follows:

Accepting Price=“Appraised Price of Reusable Components in Appliance”−“Costs for Collecting, Transportation and Disposal”

Appraised Price of Reusable Components=“Production Cost of Appliance”×“Reuse Price Factor of Components”

The “Reuse Price Factor of Components” is a ratio of the sum of current appraised prices of respective reusable components to the cost price of a new appliance. The current appraised price of a component which is reusable in producing a new appliance is “the cost price of the reusable component”×“the appraisal factor applicable to the component after the depreciation”. Thus, the reuse price factor of a reusable component j can be expressed as follows:

Reuse Price Factor of Component=(Σ_{Component j} “Cost Price of Reusable Component j”×“Appraisal Factor Applicable to Component j after Depreciation”)/“Cost Price of New Appliance”

The “Appraisal Factor Applicable to Component after Depreciation” (E, where E<1) is equal to 1−W, where the cost price of a component is equal to unity (1) and W is a depreciation factor determined in accordance with the years and months of use of the component and is smaller than unit (1). Accordingly, the appraisal factor applicable to reusable components is smaller for older components.

The manufacturer server 140 estimates the quantity of unusable remainder of each kind of appliance, and connects to the waste disposal factory server 170 to look up the transportation and disposal fee table 172 in the sever 170 to determine the fee for disposing of the unusable remainder.

At Step 312, the intermediation server 100 may connect itself to the retail shop server 150 or to the repair shop server 160 to determine whether the appliance has been repaired or not, and, if it has been and if one or more expensive components have been replaced recently, the server 100 can determine the appraised price of such relatively new, expensive components in accordance with the period of use of the components.

At Step 301 shown in FIG. 2, the consumer may select “Component Trader” on the screen of display 214, and enter the appliance data of appliance 240 which is no longer used or will become no longer used, including the kind of the appliance 240 (e.g. “refrigerator”), its product name, the name of its manufacturer, the model identification, the date of manufacture, its production number, the retail shop and the like, which data is transmitted to the intermediation server 100. If the appliance 240 is an Internet-connected appliance connected to the network 50, the consumer can operate the appliance 240 to send the appliance data in its memory via the client 200 or directly to the intermediation server 100.

Upon receipt of the input appliance data from the client 200, the intermediation server 100, at Step 313, connects itself over the network 50 to the component trader server 130 selected by the consumer or the intermediation server 100. The server 100 looks up the component market price table 132 containing kinds, names or identifications of reusable components of the appliance to determine reusable components of the appliance, and calculates the accepting price of the appliance 240 to display it on the screen of the display 214. The appliance accepting price is the price of the reusable components in the appliance 240 at which the component trader may buy them, minus various fees and costs including the appliance collection and transportation cost, the cost for removing the components from the appliance 240, and the cost for disposing of the unusable remainder of the appliance 240. Thus, the appliance accepting price may be a positive amount, zero or a negative amount. The accepting prices of the components are determined based on the date of manufacture of the appliance 240 or the period for which the components have been used. In this case, the server 100 connects itself to the retail shop server 150 or the repair shop server 160 to know whether or not the appliance has been repaired and, if any new expensive components have been used for replacement, the server 100 may determine the accepting prices of such components based on the periods of their use. The component traders can sell reusable components removed from the appliance 240 to manufacturers and repair shops.

At Step 301, the consumer may select “Secondhand Shop” from the disposal business concerns displayed on the screen of the display 214, and enters appliance data of the appliance 240 which is no longer used or will become no longer used, including the kind of the appliance 240 (e.g. “refrigerator”), the name of its manufacturer, its product name, its model identification, the date of manufacture, its production number, the retail shop name and the like, which data is transmitted to the intermediation server 100. The server 100, at Step 314, connects itself to the secondhand shop server 120 via the network 50 in accordance with the entered appliance data, and looks up the appliance and component market price table 132 to find the purchase price at which the component trader will buy the appliance 240 in the table 132. The server 100, then, causes the purchase price to be displayed on the screen of the display 214. Generally, the purchase price is a positive amount, but it maybe zero (0), or a negative amount, which means that the consumer should pay it for the disposal of the appliance 240.

When the appliance 240 does not operate well, the consumer can connect the client 200 via the intermediation server 100 to one or more of the repair shop server 160, the retail shop server 150, the manufacturer server 140 and possibly the secondhand shop server 120, and send the appliance data, including information about the failure and repair, to them, in order to know estimated costs for repairing the appliance 240 by the respective disposal business concerns. If the appliance 240 is still under guarantee, the fee for repairing the appliance 240 by the retail shop or the manufacturer may be zero (0) or reduced. Then, the consumer can know that it may be advantageous to him or her to have the appliance 240 repaired even at the cost of the repairing fee, before having it accepted by a secondhand shop. If the consumer orders the secondhand shop to accept the repaired appliance 240, the secondhand shop will present or show to the consumer the accepting market price for the appliance minus the fee for the repair, if any.

The manufacturer server 140 may be provided with a remote appliance-failure diagnosing program. In such a case, an Internet-connected appliance 240 can be connected to such manufacturer server 140 for diagnosing the failure of the appliance 240. The result of diagnosis may be entered as part of the appliance data.

In the manner as described above, the intermediation server 100 causes at Step 321 shown in FIG. 2, the display 214 of the client 200 to present one or more display screens of the one or more price lists offered by the servers 120, 130, 140 and/or 150, in accordance with the way of disposing or treating the appliance 240 selected by the consumer. The consumer, seeing the prices in the list(s) on the display 214 as offered by the servers 120, 130, 140 and/or 150, selects one of the ways of disposing of the appliance 240, displayed “Disposal at Legal Price”, “Disposal by Manufacturer”, “Disposal by Component Trader” or “Sale to Secondhand Shop”, and sends the consumer's selection to the server 100. In this case, the consumer can select one of the disposal business concerns which can provide the largest advantage to the consumer. The consumer may prefer trading with the retail shop of the appliance 240 at the legal accepting price if the accepting price offered by the manufacturer, the component trader or the secondhand shop at Step 312, 313 or 314 is a negative amount and its absolute value is larger than the legal accepting price offered by the retail shop at Step 311.

If the consumer selects “Disposal at Legal Price” at Step 321, the server 100 sends the retail shop server 150 a message of a request for accepting the appliance 240 at the legal accepting price. The request message may be sent to the server 150 by electronic mail, and the retail shop accepts the appliance from the consumer in exchange of the legal accepting price plus the collecting and transportation fee. The retail shop can evaluate the accepted appliance for himself, and can determine whether the appliance should be sold to one of the manufacturer, the component trader and the waste disposal factory, or request them to accept the appliance free of charge or by paying them some disposal fee at Step 331.

If the retail shop sells the appliance to the manufacturer, the manufacturer checks the appliance for reusable components and materials and, if any, removes them from the appliance and delivers the unusable remainder to the waste disposal factory, paying the disposal fee to the waste disposal factory.

If the retail shop delivers the appliance to the component trader, the component trader will remove reusable or recyclable components and materials from the appliance and sell them to the manufacturer or the repair shop. The unusable remainder will be accepted by the waste disposal factory in exchange of the disposal fee paid by the component trader.

If the retail shop gives the appliance to the waste disposal factory, the waste disposal factory will remove reusable components and materials, if any, from the appliance and sell or give free of charge them to various manufacturers, component traders or repair shops. The unusable remainders will be disposed of by burying or burning them.

If the consumer selects “Disposal by Manufacture” at Step 321, seeing the screen of the display 214, the server 100 sends the retail shop server 150 a message of requesting the retail shop to accept the appliance 240 at the manufacturer accepting price and deliver the appliance to the manufacturer. Such a message may be sent by electronic mail. In this case, the consumer gives the appliance to the retail shop for some money, or gives it to the retail shop free of charge or paying the accepting fee to the retail shop.

Then, the retail shop gives the money received from the consumer minus its service charge to the manufacturer, receives service charges from both of the consumer and the manufacturer, or receives from the manufacturer the money equal to the amount paid to the consumer plus its service charge, before delivering the appliance to the manufacturer.

Then, the manufacturer will remove recyclable components and materials from the appliance and deliver the unusable remainder to the waste disposal factory for disposal, paying the disposal fee. The manufacturer feeds the appliance acceptance request information into its production plan and component procurement plan. (See Step 332.) If, at Step 321, the consumer selects “Disposal by Component Trader”, the server 100 sends the retail shop server 150 a message of requesting the retail shop to accept the appliance 240 at the price for the reusable components and to deliver the appliance to the component trader. Such a message may be sent by electronic mail. In this case, the consumer gives the appliance to the retail shop for some money, or gives it to the retail shop free of charge or paying the accepting fee to the retail shop.

Then, the retail shop gives the money received from the consumer minus its service charge to the component trader, receives service charges from both of the consumer and the component trader, or receives from the component trader the money equal to the amount the retail shop paid to the consumer plus its service charge, before delivering the appliance to the component trader.

Then, the component trader will remove recyclable components and materials from the appliance, sell them to the manufacturer or the repair shop, and deliver the unusable remainder to the waste disposal factory for disposal, paying the disposal fee. (See Step 333 in FIG. 2.)

If the consumer, at Step 321, selects “Sale to Secondhand Shop”, the server 100 sends the secondhand shop server 120 a message of requesting the secondhand shop to accept the appliance 240 at the aforementioned accepting price. Such a message may be sent by electronic mail. Then, the secondhand shop staff visits the consumer and takes the appliance with him or her to the secondhand shop after paying the accepting price to the consumer. If necessary, the secondhand shop staff can re-evaluate the appliance 240 when he or she visits the consumer before determining the money to be paid to the consumer. Depending on the evaluation of the appliance, the secondhand shop may take the appliance 240 free of charge or receiving the accepting fee from the consumer. The secondhand shop may clean or repair the appliance, if necessary, and sells it as a recycled appliance. (See Step 334 in FIG. 2.)

In the embodiment described above, the consumer selects a way of disposing of the appliance 240 at Step 301 in FIG. 2, and the appliance accepting price determined in accordance with the way of disposing of the appliance 240 is presented to the consumer. However, it may be so arranged that the consumer may enter the appliance data and the like but not the way of disposing. In this case, the server 100 executes all the processing to be done at Steps 331, 332, 333 and 334 in the same manner as described above for calculation of the appliance accepting prices or fees to be received from or paid to the respective disposal traders, namely, the retail shop, the manufacturer, the component trader and the secondhand shop. The server 100 displays, on the display 214 of the client 200, a screen including a list of the calculated accepting prices or fees in such a form that the consumer can select one of them on the display 214.

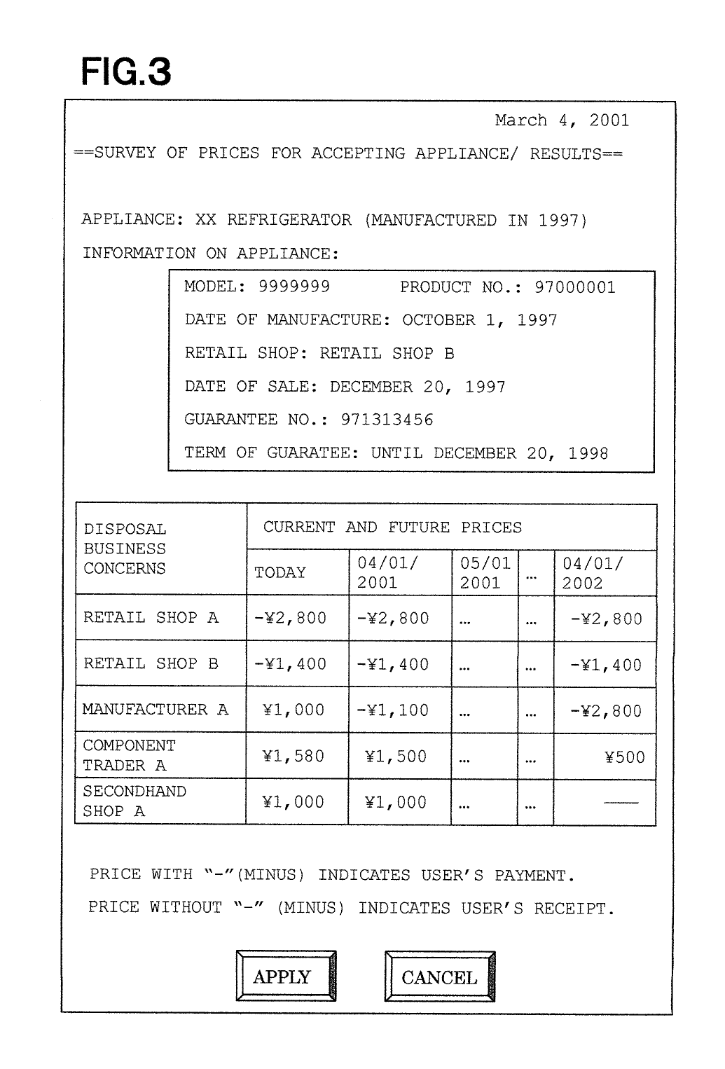

FIG. 3 shows an example of such a screen, which includes the list of the respective accepting prices or fees, as well as the appliance data of the appliance 240 entered by the consumer which the consumer is considering disposing of it.

In the example shown in FIG. 3, a retail shop A simply intermediates between consumers and waste disposal factories for disposal of appliances. Accordingly, in the columns of the accepting prices for the retail shop A, only the legal accepting fees (¥2,800 in the example of FIG. 3) are presented to the consumer, and the retail shop A will charge the full legal accepting or disposal fee to the consumer.

A retail shop B in FIG. 3 makes it a rule to bear a half of the legal accepting prices so that it may attract more consumers to it. The shop B, however, may offer a half of the legal accepting price only when a consumer will buy a new appliance of the same kind at the shop B, whereas it may offer the full legal accepting price without reduction when the consumer only requests the shop B to accept the appliance. In this case, a plurality of prices or fees for the same appliance are offered in the displayed list by the retail shop B. Then, the consumer can select one of the shops or disposal business concerns who accepts the appliance for disposal, taking into account the purchase of a new appliance.

A manufacturer A offers the legal accepting price minus the component prices of the reusable components in the appliance 240 to the consumer. The appliance 240 currently includes many reusable components, and, therefore, the sum of the component accepting prices for the reusable components is higher than the legal accepting price. Accordingly, the consumer need not pay any fee for disposing of the appliance 240. Thus, the difference between the sum of the component accepting prices and the legal accepting price is displayed in the column “Today” of the manufacturer A. In the example shown in FIG. 3, “Today” is Mar. 4, 2001.

However, one month and more than one month later, i.e. on and after Apr. 1, 2002, the number of reusable components may decrease and the prices of the reusable components may vary, so that the sum of the prices of the reusable components will be smaller than the legal accepting price for disposal. Thus, the legal accepting price minus the prices of the reusable components is indicated in the columns of “04/01/2001”, “05/01/2001” (not shown), . . . These are the amounts to be paid by the consumer to the manufacturer A. However, in Apr., 2002, there will be no reusable components in the appliance 240, and, therefore, all the legal accepting price (fee) is indicated in the column of “04/01/2002”, which means that on and after Apr. 1, 2002, the consumer will have to bear all the disposal cost.

Similarly, the accepting prices offered by a component trader A shown in FIG. 3 vary, because the number and prices of the reusable components change as time passes.

As described above, according to the present invention, consumers can determine when to dispose of a household appliance, seeing the change in market price of the appliance in the recycling market.

The consumer selects one of the most advantageous ways of disposing of his or her appliance, i.e. one of the displayed disposal business concerns in the list in the screen of FIG. 3, and clicks a software button “APPLY”. Then, the information of the appliance and the consumer who wants to have the appliance disposed of is sent to the selected one of the disposal business concerns including the retail shops A and B, the manufacturer A, the component trader A and the secondhand shop A, in the example of FIG. 3. The selected disposal business concern, then, communicates with the consumer to decide when the appliance should be taken away from the consumer by the disposal business concern, and takes the appliance with him or her on the decided date and receives or pays the accepting price. The payment may be made not directly, but via the intermediator at some intermediation service charge. In such a case, the accepting price to be displayed in the list may be determined with the intermediator's service charge taken into account.

Further, the intermediator may charge the consumer an intermediation service charge, which may be a fixed amount or a predetermined percentage of the accepting fee or price, and shows it together with the list in the screen shown in FIG. 3. The amount to be paid to or received from the consumer may be adjusted with the intermediator's service charge later.

According to the present invention, a consumer who wants to dispose of a household appliance, can easily know what ways of disposal are available and how much it costs to dispose the appliance in each of the disposal ways, and, therefore, can select an appropriate way of disposing of the appliance.

In the embodiment described above, the intermediation server 100 intermediates between the client 200 and the servers 120, 130, 140 and 150. Alternatively, the client 200 may be provided with a function similar to the recycling intermediation server function 102 implemented in the intermediation server 100 so that the client 200 can connect itself not through the intermediation server 100, but directly to one or more the servers 120-150, to select the most appropriate disposal business concern and the way of disposing. For that purpose, the program for the intermediation server function 102 may be downloaded from the server 100 or the like to the client 200.

In a still alternative embodiment, at least part of the processing functions of the servers 120, 130, 140 and 150 can be implemented as part of the intermediation server function 102 in the intermediation server 100 so that the client 200 can communicate with the intermediation server 100 only, with respect to that part of the respective processing functions of the servers 120-150, in order to make the selection of the disposal business concerns and the ways of disposing of the household appliances.

It will be understood that the above-described embodiment is only a typical example, and that people skilled in the art can readily modify it in various ways without departing the scope of the invention as defined by the accompanying claims.

What is claimed is:

1. An information processing apparatus for offering a price of an appliance to be disposed of, said information processing apparatus including a processor, said processor providing an accepting price at which said appliance is to be accepted for disposal, said accepting price being determined in accordance with appliance data of said appliance and disposal way data representing a way of disposing of said appliance.

2. The information processing apparatus according to claim 1 wherein said appliance data includes a manufacturing date on which said appliance was manufactured, and said accepting price is determined in accordance with said appliance data, said disposal way data, and an accepting date on which said appliance is to be taken away from a consumer.

3. The information processing apparatus according to claim 1 wherein said processor receives said appliance data from said appliance.

4. The information processing apparatus according to claim 1 wherein said processor receives said accepting price of said appliance from another information processing apparatus.

5. The information processing apparatus according to claim 1 wherein said processor provides said accepting price of said appliance to an apparatus of a consumer.

6. The information processing apparatus according to claim 1 wherein said processor provides, in addition to said accepting price, another accepting price of said appliance as determined in accordance with said appliance data of said appliance and another disposal way data representing another way of disposing of said appliance.

7. The information processing apparatus according to claim 1 wherein, in accordance with said disposal way data entered by a consumer, said processor further sends a message to an information processing apparatus of a business concern related to said disposal way, to request said business concern to accept and take away said appliance from said consumer.

8. The information processing apparatus according to claim 1 wherein, in accordance with said disposal way data entered by a consumer, said processor further sends said appliance data to an information processing apparatus of a business concern related to said disposal way.

9. The information processing apparatus according to claim 1 wherein said accepting price of said appliance is determined in accordance with an evaluated price of a component of said appliance and a cost for taking away said appliance from a consumer.

10. The information processing apparatus according to claim 1 wherein said processor provides a current accepting price of said appliance and a future's expected accepting price of said appliance.

11. A program recorded on a recording medium for use with an information processing apparatus for offering a price of an appliance to be disposed of, said program being operable to effect the step of providing an accepting price at which said appliance is to be accepted for disposal, said accepting price being determined in accordance with appliance data of said appliance and disposal way data representing a way of disposing of said appliance.

12. The program according to claim 11 wherein said appliance data includes a manufacturing date on which said appliance was manufactured, and said accepting price is determined in accordance with said appliance data, said disposal way data, and an accepting date on which said appliance is to be taken away from a consumer.

13. The program according to claim 11 wherein said program is operable to effect the step of receiving said appliance data from said appliance.

14. The program according to claim 11 wherein said program is operable to effect the step of receiving said accepting price of said appliance from another information processing apparatus.

15. The program according to claim 11 wherein said program is operable to effect the step of providing said accepting price of said appliance to an apparatus of a consumer.

16. The program according to claim 11 wherein the step of providing further provides another accepting price of said appliance as determined in accordance with said appliance data of said appliance and another disposal way data representing another way of disposing of said appliance.

17. The program according to claim 11 wherein said program is operable to effect the step of receiving said disposal way data from an apparatus of a consumer, said disposal way data being entered by said consumer.

18. The program according to claim 11 wherein said program is operable to further effect the step of sending, in accordance with said disposal way data entered by a consumer, a message to an information processing apparatus of a business concern related to said disposal way, to request said business concern to accept and take away said appliance from said consumer.

19. The program according to claim 11 wherein said program is operable to further effect the step of sending, in accordance with said disposal way data entered by a consumer, said appliance data to an information processing apparatus of a business concern related to said disposal way.

20. The program according to claim 11 wherein said accepting price of said appliance is determined in accordance with an evaluated price of said appliance and a cost for taking away said appliance from a consumer and disposing of said appliance.

21. The program according to claim 11 wherein said accepting price of said appliance is determined in accordance with an evaluated price of a component of said appliance and a cost for taking away said appliance from a consumer and disposing of said appliance.

22. The program according to claim 11 wherein said accepting price of said appliance is determined in accordance with a kind of said appliance, a period of time over which said appliance has been used, and information on a failure and repair of said appliance.

23. The program according to claim 11 is operable to effect the step of providing a current accepting price of said appliance and a future's expected accepting price of said appliance.

24. In an appliance accepting price offering system, a method for offering a price of an appliance to be disposed of, said method comprising the step of providing said accepting price as determined in accordance with appliance data of said appliance and disposal way data representing a way of disposing of said appliance.

25. A system for promoting recycling of appliances comprising:
receiving information related to an appliance sought to be accepted for disposal from one of a plurality of terminals over a network;
sending, in response to said received information, to said one terminal an accepting price for said appliance that is determined in accordance with an evaluated price of said appliance for recycling and with a predetermined cost for receiving and taking away said appliance, said evaluated price for recycling being predetermined by each of business concerns including a manufacturer;
receiving, from said one terminal, a request for accepting the appliance at said accepting price; and
sending, in response to said received request, another request for accepting and taking away said appliance, to one of said business concerns.
